(19) United States
(12) Patent Application Publication
(10) Pub. No.: US 2015/0148740 A1
(43) Pub. Date: May 28, 2015

(54) SYSTEM FOR AN INTERCHANGEABLE NIPPLE FOR A PACIFIER

(71) Applicant: Hermon McNac, III, Muskogee, OK (US)

(72) Inventor: Hermon McNac, III, Muskogee, OK (US)

(21) Appl. No.: 14/523,314

(22) Filed: Oct. 24, 2014

Related U.S. Application Data
(63) Continuation-in-part of application No. 14/087,577, filed on Nov. 22, 2013, now abandoned.

(51) Int. Cl. A61J 17/00

(52) U.S. Cl. CPC A61J 17/00; A61J 2017/006; A61J 2017/001; A61J 2017/008; A61J 2200/70; A61J 2200/76; A61J 2200/30
USPC 604/77

(57) ABSTRACT

An interchangeable nipple system for a pacifier for administering medicine comprising: a ring; a group of medicinal nipples, wherein each medicinal nipple is capable of connecting to the ring and each nipple includes a distinct flavor; a non-medicinal nipple, wherein the non-medicinal nipple is capable of connecting to the ring and is interchangeable with one of the group of medicinal nipples; a shield surrounds any nipple used with the pacifier, where the shield abuts a connecting ring; a threaded ring extending from the shield and connects to the connecting ring; a hole at the tip of the nipple that allows for the passage of the medicine from the medicinal nipples for administration to an infant user; and an electronic sensor that monitors the level and flow of liquid medicine in the medicinal nipples.

### CROSS REFERENCE TO OTHER APPLICATIONS

This application is a continuation in part to U.S. patent application Ser. No. 14/087,577 filed on Nov. 22, 2013.

### BACKGROUND OF THE INVENTION

1. Field of Invention

The present invention relates to a system for interchangeable nipples for a pacifier that enable the caregiver to have nipples available to delivery medicine and for traditional use by an infant.

2. Description of Related Art

A pacifier is a rubber or a plastic nipple that is given to an infant to suck on as a means to comfort and pacify the child for a brief period of time. Most pacifiers include a nipple, a shield and a holding ring. The mouth shield is usually large enough to avoid the endangerment of choking and swallowing the nipple during use. The ring is used for the handling of the nipple by the parent and in certain occasions, the child. Pacifiers are utilized for a child during the day and at night. Since when a child uses a pacifier the infant normally has a propensity to suck on the pacifier. This sucking assists the child in soothing the child and also may be helpful during the teething period. Although there have been some studies that pacifiers may be harmful, pacifiers are still commonly used by parents and therefore also have been proven to be helpful in preventing SIDS in certain instances.

It would be helpful if a caregiver had a system of nipples for use with a pacifier where nipples may be used to delivery medicine and for traditional use. The system could provide multiple flavors and nipples capable of delivering medicine.

### SUMMARY OF THE INVENTION

The present invention relates to an interchangeable nipple system for a pacifier for administering medicine comprising: a ring; a group of medicinal nipples, wherein each nipple is capable of connecting to the ring and each nipple includes a distinct flavor; a non-medicinal nipple, wherein the non-medicinal nipple is capable of connecting to the ring and is interchangeable with one of the group of medicinal nipples; a shield surrounds any nipple used with the pacifier, where the shield abuts a connecting ring; a threaded ring extending from the shield and connects to the connecting ring; a hole at the tip of the nipple that allows for the passage of the medicine from the medicinal nipples for administration to an infant user; and an electronic sensor, where the electronic sensor monitors the level and flow of liquid medicine in the medicinal nipples. Preferably, a flavoring covers the surface of each medicinal nipple and each medicinal nipple holds a predetermined amount of medicine.

### BRIEF DESCRIPTION OF DRAWINGS

FIG. 1 depicts a medicinal pacifier according to the present invention.

FIG. 2 depicts a prospective view of the components of the medicinal pacifier according to the present invention.

### DETAILED DESCRIPTION

The present invention relates to a pacifier that includes interchangeable nipples for use with an infant. A grouping of nipples may be available that are capable of delivering medicine and include flavored nipples to induce the use of the pacifier by the infant. The grouping of nipples may also include standard nipples for use in a traditional manner. The medicine delivering nipples pacifier according to present invention includes a means to insert medication within the nipple at a predetermined dosage and therefore allow the administering of the medicine while the infant enjoys sucking on the pacifier. The medicine delivering nipples of the pacifier according to present invention are flavored to enhance or diminish any unpleasant taste that may be associated with the medicine in the pacifier. The pacifier according to present invention includes a detachable nipple that allows for the insertion of the medicine within the nipple and then enables the user to reassemble the pacifier reattaching the holding ring and therefore allowing for the administration of up to a teaspoon of liquid medicine through the pacifier. The medicine is essentially self-administered by the infant through the use of the pacifier according to the present invention. Further standard nipples are available to use with the present invention.

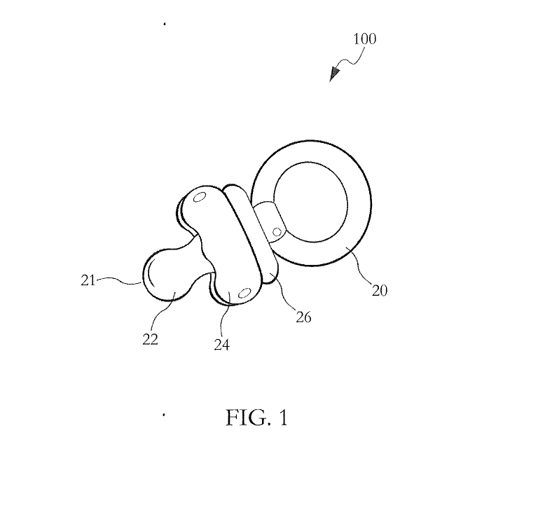

In reference to FIG. 1, a prospective view of a Pacifier 100 according to the present invention is depicted. The Pacifier 100 as shown in FIG. 1 includes a ring 20 that connects to the nipple 22. Surrounding the nipple 22 is a shield 24 that abuts a connecting ring 26. The Pacifier 100 as depicted in FIG. 1 is completely assembled and includes a hole 21 at the tip of the nipple 22 that allows for the passage of a medicine from the nipple for administration to an infant user.

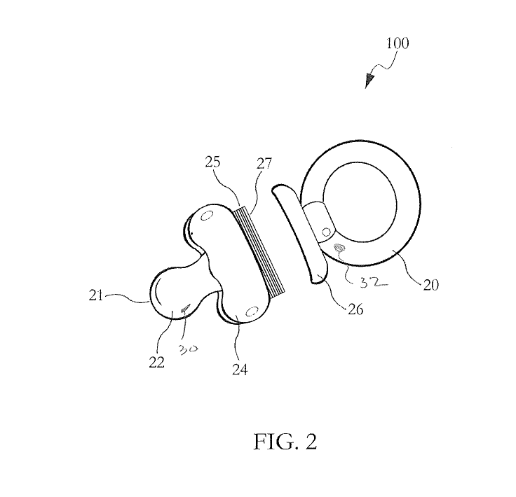

FIG. 2 depicts an exploded view of the Pacifier 100 components. As shown, ring 20 with the connecting ring 26 separates from the nipple assembly. Extending from the shield 24 of the nipple assembly is a threaded ring 25 that connects with the connecting ring 26 as shown. An opening 27 is provided that allows for the insertion of medicine within the inside of the nipple 22. After the appropriate level of medication is inserted within the nipple 22, the connecting ring 26 is screwed upon the threaded ring 25 and sealed for use. When in use, the infant upon sucking upon the nipple 22 receives a delivery of medicine through the hole 21 of the nipple 22.

In addition to providing a means for the insertion for medicine within the nipple 22, the outer surface of the nipple 22 is covered with a flavoring that enhances and appeals to an infant. The flavoring helps to mask the taste of the medicine and entices the infant to suck upon the nipple. The nipple, as with many nipples, may be made of latex, silicone, or plastic materials. The shaping of the nipple may be appropriate for the reception of the nipple into the child's mouth. Also, the interior of the nipple may be able to hold up to a tablespoon of liquids for administration through the nipple. The use of the pacifier according to the present invention helps to reduce spillage, gagging, or spitting up of the medicine due to the administration of the medicine through the nipple essentially at the child's own pace. Use of the present invention advantageously supplies a means for the administration of medicine and also for the comforting of the infant during the administration of the medicine.

As stated, nipple 22 may be a medicinal nipple capable of delivering medicine. The medicinal nipple may be provided in multiple flavors. As a consequence, the caregiver may have multiple flavors of medicinal nipples available to be used with the present system. Flavors may vary in type such as orange, grape, cherry, vanilla or even chocolate. These multiple flavors are kept in a sanitary container until used by the user. In one particular embodiment of the present invention, these medicinal nipples are single-use nipples therefore once used the flavoring diminishes on the nipple and the nipple must be discarded for replacement by the caregiver. Once the medicine is delivered to an infant, a caregiver may then remove the medicinal nipple from the pacifier and insert a traditional nipple for use with the infant. The advantage of using this traditional nipple is that the caregiver may have available multiple flavors of medicinal nipples and a standard nipple that is non-flavored. Further with respect to the flavored coating, the coating is flavored without the use of sugar or additives that may be harmful to the infant's gums and therefore diminish any health risks associated with the medicinal nipple.

Further the medicinal nipple may be equipped with an electrical sensor 30 within the nipple 22, shown in FIG. 2. This electrical sensor 30 detects the completion of the delivery of medicine through the nipple. Once the liquid medicine is removed from the nipple through the baby's use the sensor 30 provides an alert indicating that delivery of the medicine is complete. In one particular embodiment, the sensor 30 may illuminate a small light 32 on the pacifier indicating that the medicine has been consumed by the infant. Further the caregiver may also confirm the delivery of medicine by physically checking the condition of the nipple and the surrounding areas of the infant. The electrical sensor used in accordance with the present invention is able to detect the volume of liquid within the nipple. Once the volume of liquid decreases to a preset parameter, the sensor activates an alert on the pacifier indicating that the medicine has been consumed.

The instant invention has been shown and described in what it considers to be the most practical and preferred embodiments. It is recognized, however, that departures may be made there from within the scope of the invention and that obvious modifications will occur to a person skilled in the art.

What is claimed is:

1. An interchangeable nipple system for a pacifier for administering medicine comprising:
a. a ring;
b. a group of medicinal nipples, wherein each medicinal nipple is capable of connecting to the ring and each medicinal nipple includes a distinct flavor;
c. a non-medicinal nipple, wherein the non-medicinal nipple is capable of connecting to the ring and is interchangeable with one of the group of medicinal nipples;
d. a shield surrounds any nipple used with the pacifier, where the shield abuts a connecting ring;
e. a threaded ring extending from the shield and connects to the connecting ring;
f. a hole at the tip of the nipple that allows for the passage of the medicine from the medicinal nipples for administration to an infant user; and
g. an electronic sensor, where the electronic sensor monitors the level and flow of liquid medicine in the medicinal nipples.

2. The interchangeable nipple system for a pacifier according to claim 1, where a flavoring covers the surface of each medicinal nipple.

3. The interchangeable nipple system for a pacifier according to claim 2, where the flavoring has a predetermined use cycle.

4. The interchangeable nipple system for a pacifier according to claim 1, where the nipple holds a predetermined amount of medicine.

5. The interchangeable nipple system for a pacifier according to claim 1, where the sensor provides an alert indicating that the delivery of the medicine is complete.

6. The interchangeable nipple system for a pacifier according to claim 6, where the alert includes a small light on the pacifier.
